(19) United States
(12) Patent Application Publication
(10) Pub. No.: US 2004/0017769 A1
(43) Pub. Date: Jan. 29, 2004

(54) Method of establishing a route redundancy in a data transmission system using static routes

(75) Inventors: Lionel Denecheau, La Colle sur Loup (FR); Denis Esteve, Vence (FR); Pierre Russeil, Valbonne (FR); Patrick Sicsic, La Colle sur Loup (FR)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/411,593

(22) Filed: Apr. 10, 2003

(30) Foreign Application Priority Data
Apr. 11, 2002 (EP) 02368037.4

(51) Int. Cl. H04L 1/00

(52) U.S. Cl. 370/218; 370/252

(57) ABSTRACT

Method of establishing a route redundancy in a data transmission system using static routes, this system comprising a plurality of networks and a plurality of routers, a defined router (70) being able to use several routes to reach a destination network (72). This method comprises the steps of defining all the static routes toward the destination network, verifying for each defined static route whether the destination network is reachable resulting in a set of static routes considered as eligible to be used, defining a priority for each route of the set of static routes, and selecting the static route having the highest priority as the route to be used. A conventional static route may be used if none of these static routes is available.

### TECHNICAL FIELD

The present invention relates to data transmission systems wherein several routes can be used to transmit data from a router to a destination network and relates particularly to a method of establishing a route redundancy in a data transmission system using static routes.

### BACKGROUND

The route redundancy used in a data transmission system including a plurality of routers operates generally with dynamic routing protocols. When a route is lost, routing updates are exchanged between the routers and a new route is found and advertised to all the routers.

But route redundancy cannot be used with static routes because static routes permanently remain in the routing table of the router when the destination is no longer reachable. The only case where a static route can be dynamically modified is when the output interface goes down. In such a case, the static route is removed from the routing table and another route can be used instead. However, if a remote failure not affecting the output interface on the router occurs in the path, the router will still keep on using the static route toward the same path.

In spite of this drawback, static routes are very often used by the companies (such banks) that require high security and do not want to see route information flooding over no-private links. Furthermore, static routes are still widely used in the today networks because they offer a better control of the traffic and they do not introduce any overhead on the links (no routing updates are exchanged).

The private companies which require a high security are generally using firewalls for controlling traffic between sites and blocking undesirable users to come in. These firewalls usually do not allow dynamic routing for security reasons and more generally block all multicast packets used by all routing protocols. In such a case, only static routing can be used despite the drawback mentioned above.

### SUMMARY OF THE INVENTION

Accordingly, the main object of the invention is to achieve a method of establishing a route redundancy in a data transmission system using static routes.

The invention relates therefore to a method of establishing a route redundancy in a data transmission system using static routes and comprising a plurality of networks and a plurality of routers, a defined router being able to use several routes to reach a destination network. This method includes the steps of defining all the static routes toward the destination network, verifying for each defined static route whether the destination network is reachable resulting in a set of static routes considered as eligible to be used, defining a priority for each route of the set of static routes, and selecting the static route having the highest priority as the route to be used. This method does not exclude the configuration on a same router of conventional static routes.

### BRIEF DESCRIPTION OF THE DRAWINGS

The above and other objects, features and advantages of the invention will be better understood by reading the following more particular description of the invention in conjunction with the accompanying drawings wherein :

Fig. 1 is a flow chart representing the steps of the method according to the invention,

Fig. 2 is a flow chart representing the steps of the process used to check the availability of a route,

Fig. 3 is a block-diagram of a first example wherein the method according to the invention is used,

Fig. 4 is block-diagram of a second example wherein the method according to the invention is used.

### DETAILED DESCRIPTION OF THE INVENTION

The principle of the invention is to define multiple static routes toward a destination network, with different priorities (or preferences) and conditionally use them in the IP routing table of the source router. The condition is based upon the reachability of a specific destination address. As long as the destination address is reachable, the path is considered as valid and the route is eligible for the IP routing table. When the destination address is no longer reachable, the path is considered as invalid and the route is no longer eligible for the routing table.

In order to allow redundancy, several static routes must be defined. In case several routes are eligible, only one can be used in the IP routing table. The priority (or preference) is used to select which one of the valid routes is selected.

The destination address used as the condition is the IP address of the last router in the path, i.e. the IP address of the router interface connected to the destination network. If this router interface can be reached, it is assumed that the destination network located just behind it is reachable too. This principle can be implemented several times along a path.

The checking of the reachability of a destination address is based on the ICMP Echo Request and Echo Reply messages also known as ping messages. At every predefined checking interval (e.g. 60 s), an ICMP Echo Request (ping) is sent to the destination address and the routers wait for an ICMP Echo Reply message. If such a message is received, the path is considered as reachable whereas for three consecutive ICMP Echo Requests not responded, the route is considered as lost. When a route is invalid, the router keeps on checking it every checking interval. If three consecutive Echo Requests are responded, then the route is considered back as valid. This checking based on three consecutive answers is to avoid route flapping in case of a loss of a single flapping. Note that any other protocol could be used to poll the remote router, including any new specific protocol. However, using ICMP brings an advantage in that any router supporting the ICMP Echo Request/Reply, no code change is required in the remote router.

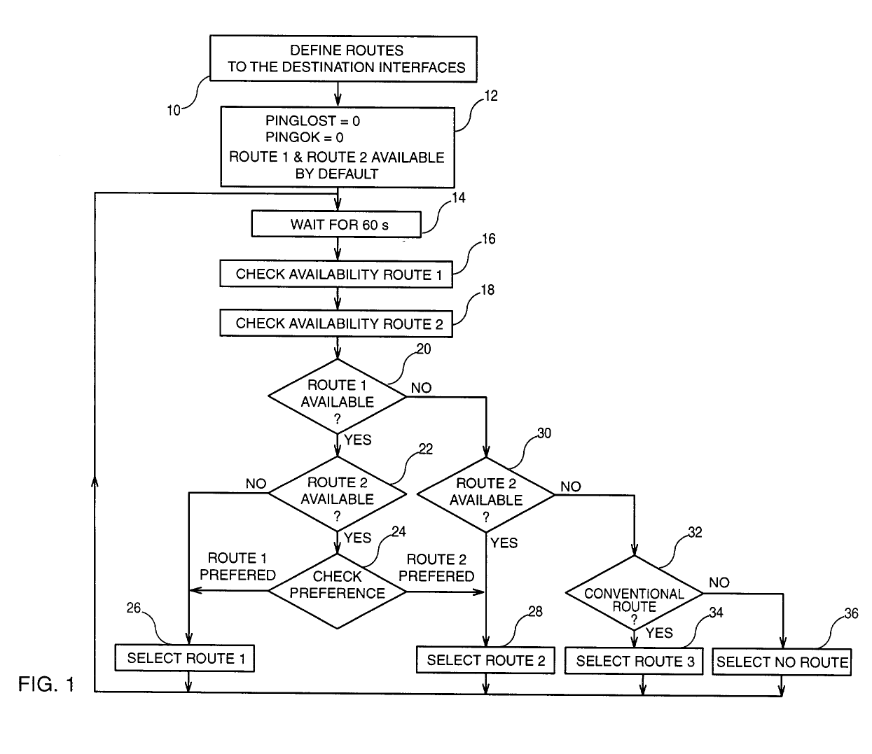

Assuming that the communication from a router to a remote network may be achieved by using two routes (there could be more than two routes), the method according to the invention is illustrated in FIG. 1.

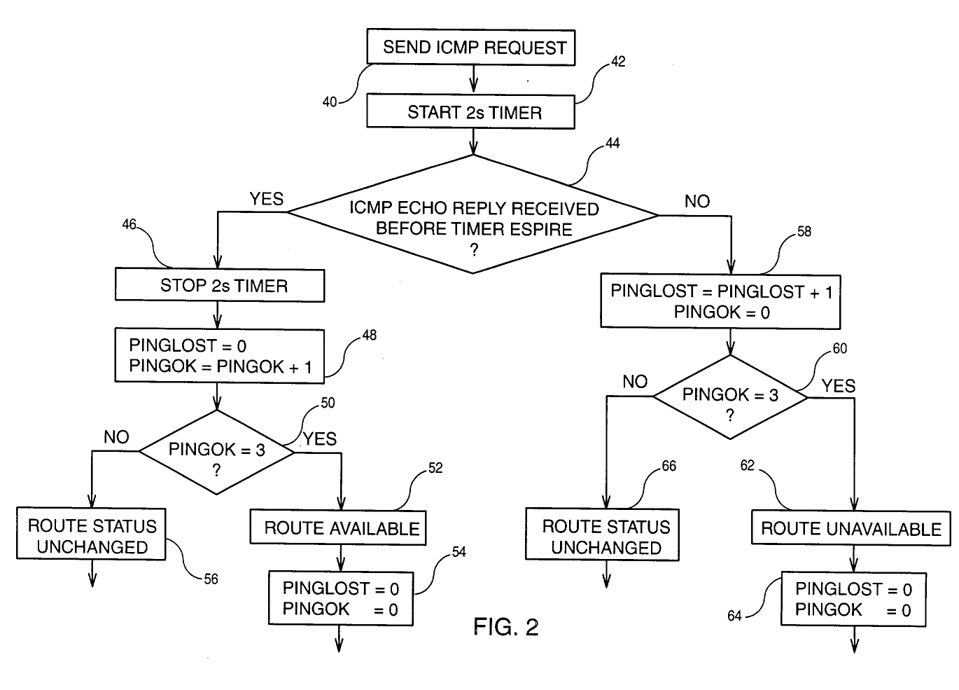

First of all, the two specific routes to the interfaces of the remote network are defined (step 10). Then, two variables PINGLOST and PINGOK are set to 0 and the route 1 and 2 are set as reachable by default (step 12). Because the checking of the route availability is achieved every time interval of 60 s, the process is waiting during 60 s (step 14) before checking the availability of the route 1 (step 16) and of the route 2 (step 18) as described hereafter in reference to FIG. 2.

After that, the first question is whether Route 1 is available (step 20). If so, the second question is to know whether Route 2 is also available (step 22). If the two routes are available, the process has to check which route is preferred based upon the priority (step 24). Assuming Route 1 is preferred, Route 1 is selected (step 26) whereas Route 2 is selected (step 28) if Route 2 is preferred.

When Route 1 is not available, the question is to know whether Route 2 is available (step 30). If so, Route 2 is selected (step 28) whatever the preference is since Route 1 is not available. If Route 2 is not available the following question is to know whether there is a conventional route (step 32). A conventional static route is a static route as usually known without reachability checking done. Reachability checking on static routes as described here, should not be used on dial up links such as ISDN because the periodic checking would keep the line active and cause unnecessary expenses. If it is the case, this route is selected (step 34). If not, no route can be selected (step 36).

Now, the steps of the process used to check the availability of a route (step 16 or step 18) are represented by the flow chart in FIG. 2. First, an ICMP request is sent over the route to be checked (step 40). Upon transmission, a timer of 2 s is started (step 42) and it is checked whether an ICMP ECHO Reply is received before the timer expires (step 44). This method allows to ignore a route which is still reachable, but with low performances.

If an ICMP Echo Reply is received before the timer expires, the 2 s timer is stopped (step 46). The variable PINGLOST is reset to 0 and the variable PINGOK is incremented by one (step 48). It is then checked whether the variable PINGOK has reached the value 3 (step 50). If so, this means that the route has become available (step 52) and the variables PINGLOST and PINGOK are reset to 0 (step 54). If not, the route status is not changed (step 56).

If no ICMP Echo Reply is received before the 2 s timer expires, the variable PINGLOST is incremented by 1 and the variable PINGOK is reset to 0 (step 58). It is then checked whether the variable PINGLOST has reached the value 3 (step 60). If so, this means that the route has become unavailable (step 62) and the variables PINGLOST and PINGOK are reset to 0 (step 64). If not, the route status is not changed (step 66).

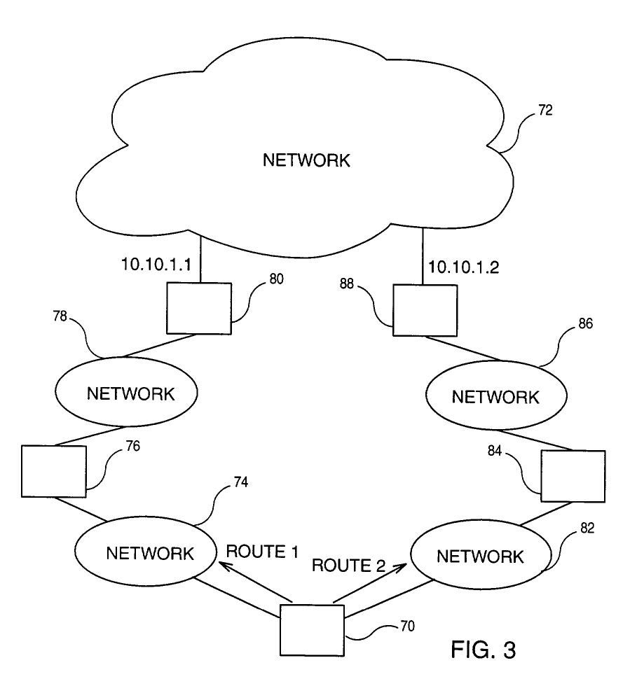

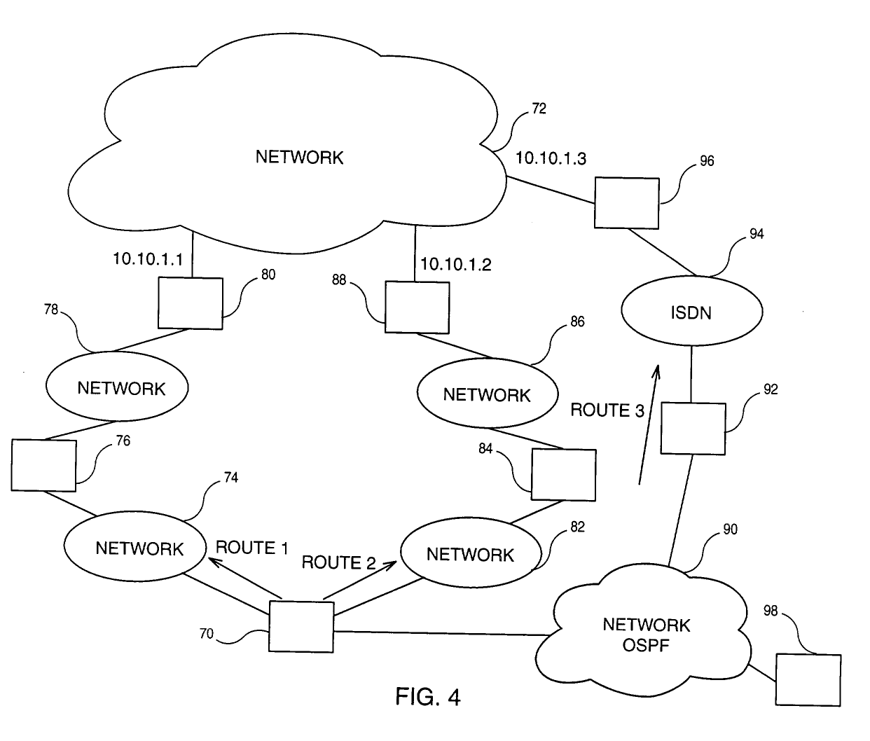

Two examples of communication systems wherein the method according to the invention can be implemented are described in reference to FIG. 3 and FIG. 4. In the first example illustrated in FIG. 3, a router 70 needs to reach the destination network 72. It is assumed that two conditional static routes can be configured. Route 1 is composed of network 74, router 76, network 78 and router 80 to reach the interface 18 network 72 the address of which is 10.10.1.1. Route 2 is composed of network 82, router 84, network 86 and router 88 to reach interface 2 to network 72 the address of which is 10.10.1.2.

Accordingly, the condition on Route 1 is the reachability of interface 10.10.1.1. and the condition on Route 2 is the reachability of interface 10.10.1.2. In addition, a priority or preference is set on each route, for example priority 1 (route preferred) on Route 1 and priority 2 on Route 2. This means that, if both routes are available, Route 1 will be preferred over Route 2.

The method according to the invention is implemented as follows

two specific routes to destination interfaces are recorded in the routing table of router 70. They are used to direct the ping to the right path in order to avoid a ping from reaching interface 1 via route 2 or vice-versa,

the router 70 assumes that Route 1 and Route 2 are available but adds Route 1 as the preferred route in its routing table. Therefore, all traffic transmitted to network 72 goes via Route 1,

the router 70 checks every 60 s, the availability of Route 1 and Route 2 by checking the reachability of the routes to interface 1 and to interface 2. For this, the router sends an ICMP Echo Request (ping) to interface 1 address and an ICMP Echo Request to interface 2 address. The ping to 10.10.1.1. will use Route 1 whereas the ping 10.10.1.2. will use Route 2. After a series of 3 successful pings, a route is considered as available is already described in reference to FIG. 2, and conversely a route is considered as unavailable after a series of 3 unsuccessful pings. Otherwise, the route remains in the same status (available if it was available, unavailable if it was unavailable),

note that a ping is considered unsuccessful if the ICMP Echo Reply has not been received within 2 seconds after the Echo Request has been sent, (this allows to ignore a route reachable but experiencing performance problems).

if both routes are considered as available (i.e. Pings are successful) only the preferred route (here Route 1) is selected in the routing table and all the traffic to network 72 keeps on using Route 1.

if Route 2 becomes unavailable but Route 1 is still available, then Route 1 is kept and nothing is modified.

if Route 2 is available but Route 1 becomes unreachable, for example due to a failure of the link between the two routers 76 and 80, then Route 1 is removed from the routing table and Route 2 is added for selection in the routing table. At that time, all the traffic to network 72 is transmitted over Route 2.

In some cases, one of the static routes goes through a dial up network such as ISDN. It is a very common configuration when a router is connected to a network via a serial line and a dial up connection such as ISDN provides the backup. Using a conditional route as defined above would cause a problem since sending a ping via this route every checking interval (60 s) would keep the dial up link up all the time, and generate unnecessary expenses.

Accordingly, the solution in the above case is to use, on the leased line, a conditional static route as previously described and, on the dial-up line, the conventional static route with a least preference. Assuming that, in FIG. 3, network 82 is ISDN, Route 1 can be defined as a conditional route and Route 2 as a conventional route. Route 2 will be available all the time like a usual static route, but it will not be used until Route 1 becomes unavailable.

Therefore, the method is almost the same as previously. But no pings are sent over Route 2 every 60 s. As long as Route 1 is available (i.e. pings are successful), it is kept in the routing table and all the traffic to network 72 keeps on using Route 1. If Route 1 becomes unreachable, since Route 2 is always available, then Route 1 is removed from the routing table and Route 2 is added to the routing table. At this stage, all the traffic goes through network 82, using the dial up link.

FIG. 4 is a block diagram representing a specific case wherein the system of FIG. 3 is included in a large system incorporated a network 90 using a routing protocol such as OSPF for dynamically determining the route to be used to reach network 72. This is a common situation when a customer wants to connect network 90 to network 72 over a third party network (e.g. networks 74 and 82) where only static routes are allowed for security reasons.

In such a case, router 70 will use a conditional static Route 1 or Route 2 to reach network 72 while a router 92 connected to network 90 will use a conventional static route via a dial up network 94 and a router 96 wherein the interface to network 72 has the address 10.10.1.3. Assuming that a router 98 is used to establish the route to network 72, routers 70 and 92 will advertise their static route to router 98 using redistribution into the dynamic routing protocol OSPF. Assuming that Route 1 is preferred to route 2 (Route 1 has a higher priority than Route 2), router 70 will advertise route 1 to routers 98 and 92 over network 90 using OSPF. Router 92 will advertise route 3 to routers 98 and 70 over network 90 using OSPF. Router 98 will then receive 2 routes to network 70, route 1 from router 70 and route 3 from router 92. The OSPF cost setting on routers 70 and 92 will allow router 98 to select the proper route. We assume OSPF cost of route 3 is higher than route 1 and 2. To summarize, when route 1 is available, it is selected; when route 1 is unavailable, route 2 is selected; when both route 1 and 2 are unavailable, route 3 is selected by router 98. Note: This method works with any combination of N routers, using conditional or conventional static routes or both.

1. Method of establishing a route redundancy in a data transmission system using static routes, said system comprising a plurality of networks and of routers, a defined router (70) being able to use several routes to reach a destination network (72);
said method being characterized in that it comprises the steps of:
defining all the static routes toward said destination network (10),
verifying for each defined static route whether said destination network is reachable (20, 22) resulting in a set of static routes considered as eligible to be used,
defining a priority for each route of said set of static routes (24), and
selecting the static route having the highest priority as the route to be used (26, 28).

2. Method according to claim 1, wherein the step of verifying (20, 22) whether said destination network is reachable consists in sending an ICMP Echo Request from said defined router (70) to said destination network.

3. Method according to claim 1, wherein said ICMP Echo Request is sent every 60 s to said destination network.

4. Method according to claim 2 or 3, wherein said destination network is considered reachable if an ICMP Echo Reply is received from said destination network within a predetermined period of time (2 s) after said ICMP Echo Request was sent.

5. Method according to claim 4, wherein a static route which was available is considered unavailable when three consecutive ICMP Echo Request messages have not been responded within said predetermined period of time.

6. Method according to claim 5, wherein a static route which was unavailable is considered available when three consecutive ICMP Echo Request messages have been responded within said predetermined period of time.

7. Method according to claim 6, wherein a conventional route can be used when all static routes have been considered unavailable because three consecutive ICMP Echo Request messages have not been responded within said predetermined period of time.

8. Method according to claim 7, wherein said conventional route goes through a dial-up network.

9. Data transmission system comprising means adapted for carrying out the steps of the method according to any one of claims 1 to 8.

10. Data transmission system according to claim 9, further comprising a specific network using a routing protocol such as OSPF protocol in which a router (98) can reach said destination network (72) by using either one of said static routes (Route 1, Route 2) or a conventional route (Route 3), and wherein said defined router (70) advertises said static routes to said routing protocol and said routing protocol sets costs for said static routes which are lower than the cost for said conventional route so that said destination network is reached by one of said static routes when at least one of them is available.

11. Data transmission system according to claim 10, wherein said defined router (70) stops advertising said static routes to said routing protocol when said static routes are all unavailable so that said conventional route (Route 3) is used by said router (98) to reach said destination network (72).
